(19) United States
(12) Patent Application Publication
(10) Pub. No.: US 2007/0040637 A1
(43) Pub. Date: Feb. 22, 2007

(54) Microelectromechanical switches having mechanically active components which are electrically isolated from components of the switch used for the transmission of signals

(76) Inventors: Ian Y. K. Yee, Austin, TX (US); William G. Flynn, Austin, TX (US)

Correspondence Address: DAFFER MCDANEIL LLP, P.O. BOX 684908, AUSTIN, TX, 78768, US

(21) Appl. No.: 11/207,324

(22) Filed: Aug. 19, 2005

(51) Int. Cl. H01H 51/22

(52) U.S. Cl. 335/78

(57) ABSTRACT

A plate-based microelectromechanical system (MEMS) switch is provided which includes a moveable plate suspended above a substrate and a plurality of arms extending from the periphery of the moveable plate. The moveable plate includes a first electrode suspended over a second electrode arranged on the substrate and a first input/output signal contact structure electrically isolated from the first electrode. In some embodiments, the first input/output signal contact structure is arranged proximate to the edge of the moveable plate. In addition or alternatively, one of the arms is electrically coupled to the first input/output signal contact structure and comprises an input/output signal trace. A cantilever-based MEMS switch is provided which includes a cantilever structure with a first electrode suspended a second electrode arranged upon a substrate. In addition, the cantilever structure includes an input/output signal line spaced apart from the first electrode and arranged above an input/output signal contact structure.

### BACKGROUND OF THE INVENTION

1. Field of the Invention

This invention relates to microelectromechanical devices, and more particularly, to microelectromechanical devices having mechanically active components which are electrically isolated from components used for the transmission of signals through the device.

2. Description of the Related Art

The following descriptions and examples are not admitted to be prior art by virtue of their inclusion within this section.

Microelectromechanical devices, or devices made using microelectromechanical systems (MEMS) technology, are of interest in part because of their potential for allowing integration of high-quality devices with circuits formed using integrated circuit (IC) technology. As compared to transistor switches formed with conventional IC technology, for example, microelectromechanical contact switches may exhibit lower losses and a higher ratio of off-impedance to on-impedance. MEMS switch designs generally include a moveable electrode in the form of a beam or a plate suspended above a fixed electrode. In addition, MEMS switches generally include one or more contact structures arranged along the same plane as the fixed electrode, but isolated therefrom and, in some embodiments, may further include one or more contact structures arranged along the underside of the beam. Upon actuation of the switch, the moveable electrode moves such that the moveable electrode itself or contact structures coupled to the moveable electrode make contact with the contact structures arranged adjacent to the fixed electrode. This often is referred to as the “on state” or “closed state” of the switch. An “off state” or “open state” of the switch corresponds to a state in which the switch is not actuated and, therefore, contact between the moveable electrode and the contact structures is not made.

While some of the contact structures may be configured to prevent the moveable electrode from contacting the fixed electrode during the on state, some of the contact structures may further be “input/output signal contacts” in that they are used to pass and receive current between input and output signal traces within the switch. In particular, during an on state, the input/output signal contact structures may be used to couple input and output signal traces within the switch to complete a signal circuit. In some embodiments, the input and output signal traces may be arranged within the same plane as the fixed electrode and an input/output signal contact structure may be dielectrically suspended by the moveable beam directly over the two traces. Thus, upon lowering the moveable electrode, the input/output signal contact may complete a circuit between the input and output traces. Such a configuration is referred to herein as a “dual point contact switch” since a minimum of two points of contact are used to complete the signal circuit between the input and output terminals of the device.

In some embodiments, the moveable beam may serve a role as an input/output signal trace as well as an electrode used to open and close the switch. In particular, the moveable beam may be used to mechanically close the switch in conjunction with the actuation of the switch as well as transmit an input/output signal to or from another input/output trace arranged on the same plane as the fixed electrode. Circuit configurations employing such a moveable electrode may use, as a minimum, one point of contact to complete the circuit and, therefore, is referred to herein as a “single point contact switch.” It is noted that the terms “single point” and “dual point” refer to the minimum number of points of contact in series which are needed to complete a signal circuit. Such a definition, however, does not preclude switch configurations from having multiple points of contact in parallel. In particular, each of these terms may refer to switches having points of contact that are arranged exclusively in series as well as switches having one or more sets of contacts which are arranged in parallel.

A single point contact switch may advantageously provide a lower resistance switch as compared to a dual point contact switch, but enhancement of the electrical and mechanical properties of conventional single point contact switches are often conflicting. In particular, it is generally advantageous to increase the size of an input/output signal trace to decrease on-impedance through the switch, but an electrode of larger size is generally more difficult to move uniformly. As a result, a trade-off exists in conventional single point contact switches for optimizing on-impedance and fabricating a switch which will reliably open and close. In addition, both single point and dual point contact switches experience energy leakage due to the narrow spacing between conductive components and input/output signal traces and/or input/output signal contact structures within the switch. In particular, it is generally advantageous to position components of a switch in close proximity to reduce the size of the switch and the optimize amount of mechanical action used to operate the switch. As a consequence, however, capacitive coupling between structures may, in some embodiments, be high enough to cause high-frequency energy from one input/output trace to leak to an opposing structure even when the switch is in the off state. The energy leakage is sometimes referred to as poor isolation and generally worsens as the capacitive coupling between the components increases.

It would, therefore, be desirable to develop MEMS switches which are less susceptible to energy leaking due to capacitive coupling. In addition, it would be beneficial to develop single point contact MEMS switches having components which are configured to induce mechanical action of the switch independent of components for transmitting signals through the switch.

### SUMMARY OF THE INVENTION

The problems outlined above may be in large part addressed by configurations of microelectromechanical (MEMS) switches having mechanically active components which are electrically isolated from components used for the transmission of signals through the switch. The following are mere exemplary embodiments of the MEMS switches and are not to be construed in any way to limit the subject matter of the claims.

One embodiment of the MEMS switches includes a moveable plate suspended above a substrate, a plurality of arms extending from the periphery of the moveable plate, and a plurality of support structures coupled between the plurality of arms and the substrate. The moveable plate includes a first electrode suspended over a second electrode arranged on the substrate and a first input/output signal contact structure electrically isolated from the first electrode. The first input/output signal contact structure is arranged proximate to the edge of the moveable plate and is suspended above a second input/output signal contact structure arranged on the substrate and spaced apart from the second electrode.

Another embodiment of the MEMS switches includes a moveable plate suspended above a substrate, a plurality of arms extending from the periphery of the moveable plate, and a plurality of support structures coupled between the plurality of arms and the substrate. The moveable plate includes a first electrode suspended over a second electrode arranged on the substrate and a first input/output signal contact structure electrically isolated from the first electrode. One of the plurality of arms is electrically coupled to the first input/output signal contact structure and comprises an input/output signal trace. In addition, the first input/output signal contact structure is suspended above a second input/output signal contact structure arranged on the substrate and spaced apart from the second electrode.

Another embodiment of the MEMS switches includes a first electrode arranged upon a substrate and an input/output signal contact structure arranged upon the substrate and spaced apart from the first electrode. The MEMS switch further includes a cantilever structure with a second electrode suspended above the first electrode and an input/output signal line spaced apart from the second electrode and arranged above the input/output signal contact structure.

### BRIEF DESCRIPTION OF THE DRAWINGS

Other objects and advantages of the invention will become apparent upon reading the following detailed description and upon reference to the accompanying drawings in which:

FIG. 1a depicts a plan view of an exemplary configuration of a plate-base MEMS switch;

FIG. 1b depicts a cross-sectional view of the plate-based MEMS switch illustrated in FIG. 1a taken along line AA;

FIG. 2 depicts a plan view of the suspended level of components within the plate-based MEMS switch illustrated in FIG. 1a;

FIG. 3a depicts a plan view of the first level of components within the plate-based MEMS switch illustrated in FIG. 1a;

FIG. 3b depicts a plan view of an alternative configuration for the first level of components within the plate-based MEMS switch illustrated in FIG. 1a;

FIG. 4a depicts a plan view of another exemplary configuration of a plate-based MEMS switch;

FIG. 4b depicts a cross-sectional view of the plate-based MEMS switch illustrated in FIG. 4a taken along line BB;

FIG. 5a depicts a plan view of another exemplary configuration of a plate-based MEMS switch;

FIG. 5b depicts a cross-sectional view of the plate-based MEMS switch illustrated in FIG. 5a taken along line CC;

FIG. 6a depicts a plan view of an exemplary configuration of a cantilever-based MEMS switch;

FIG. 6b depicts a cross-sectional view of the cantilever-based MEMS switch illustrated in FIG. 6a taken along line DD;

FIG. 6c depicts a cross-sectional view of the cantilever-based MEMS switch illustrated in FIG. 6a taken along line EE;

FIG. 7a depicts a plan view of another exemplary configuration of a cantilever-based MEMS switch;

FIG. 7b depicts a cross-sectional view of the cantilever-based MEMS switch illustrated in FIG. 7a taken along line FF;

FIG. 7c depicts a cross-sectional view of the cantilever-based MEMS switch illustrated in FIG. 7a taken along line GG;

FIG. 8a depicts a plan view of another exemplary configuration of a cantilever-based MEMS switch;

FIG. 8b depicts a cross-sectional view of the cantilever-based MEMS switch illustrated in FIG. 8a taken along line HH;

FIG. 8c depicts a cross-sectional view of the cantilever-based MEMS switch illustrated in FIG. 8a taken along line JJ;

FIG. 9a depicts a plan view of another exemplary configuration of a cantilever-based MEMS switch;

FIG. 9b depicts a cross-sectional view of the cantilever-based MEMS switch illustrated in FIG. 9a taken along line KK;

FIG. 9c depicts a cross-sectional view of the cantilever-based MEMS switch illustrated in FIG. 9a taken along line LL;

FIG. 10a depicts a plan view of another exemplary configuration of a cantilever-based MEMS switch;

FIG. 10b depicts a cross-sectional view of the cantilever-based MEMS switch illustrated in FIG. 10a taken along line MM; and

FIG. 10c depicts a cross-sectional view of the cantilever-based MEMS switch illustrated in FIG. 10a taken along line NN.

While the invention may include various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

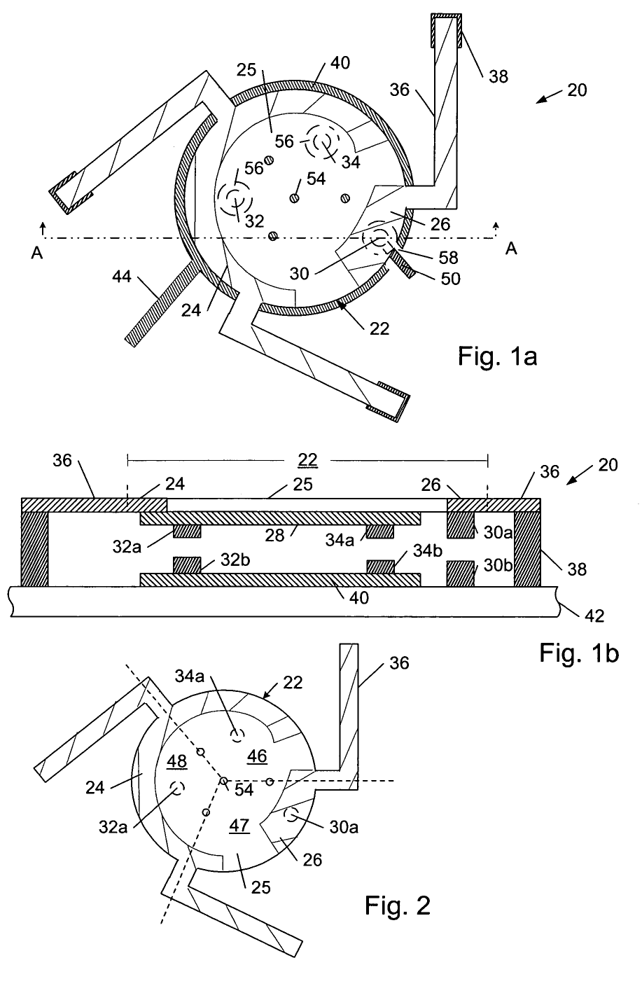

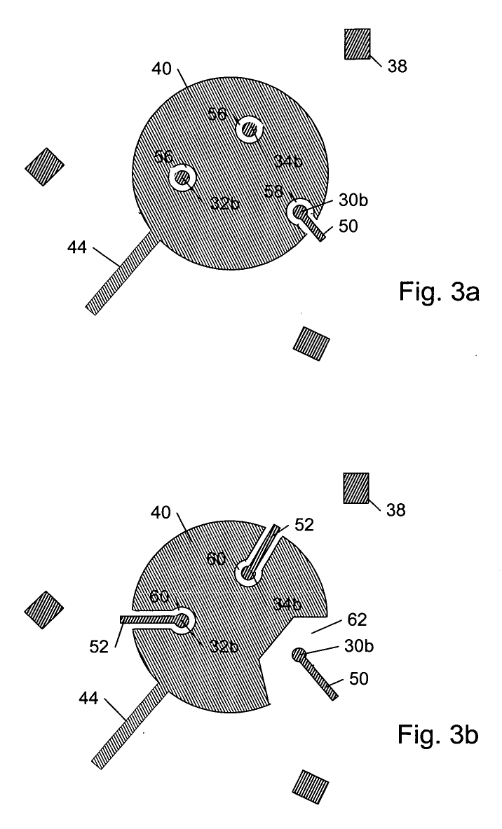

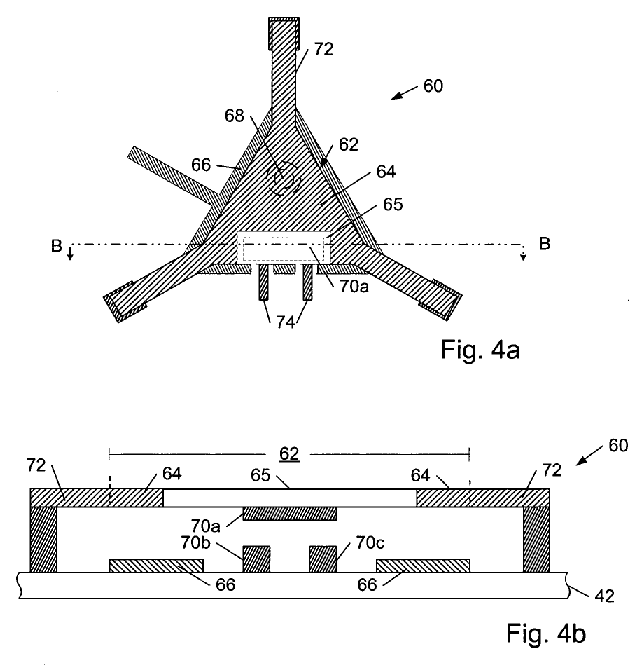

Turning to the drawings, exemplary configurations of microelectromechanical system (MEMS) switches are shown having mechanically active components which are electrically isolated from components of the switch used for the transmission of signals. For example, FIGS. 1a and 1b illustrate MEMS switch 20 with moveable plate 22 including input/output signal contact structure 30 electrically isolated from moveable electrode 24, which in conjunction with fixed electrode 40 is configured to cycle the switch open and closed. FIG. 1a is a plan view of MEMS switch 20 and FIG. 1b is a cross-sectional view of MEMS switch 20 taken along line AA of FIG. 1a. Exemplary configurations of upper and lower level components of MEMS switch 20 are illustrated in FIGS. 2, 3a and 3b and are referenced concurrently with FIGS. 1a and 1b to describe MEMS switch 20. In particular, FIG. 2 illustrates a plan view of the upper components of MEMS switch 20 (i.e., support arms 36 and moveable plate 22, including conductive members 24 and 26, insulating member 25, and contact structures 30a, 32a and 34a). In addition, FIGS. 3a and 3b illustrate plan views of different configurations for the lower components of MEMS switch 20 (i.e., fixed electrode 40, support vias 38, contact structures 30b, 32b and 34b, signal traces 50 and 52, and actuation line 44). Other exemplary configurations of MEMS switches including components having alternative configurations to plate-based MEMS switch 20 as well as cantilever-based MEMS switches are illustrated in FIGS. 4a-10c and discussed in more detail below. It is noted that the images depicted in FIGS. 1a-10c are not necessarily drawn to scale. In particular, some features of the MEMS switches shown may be disproportionately sized relative to other features in the interest to emphasize particular aspects of the switches.

MEMS switch designs are often characterized by the form of their moveable component/s and, therefore, MEMS switch 20 may be characterized as a plate-based MEMS switch. Other types of MEMS switches include cantilever-based MEMS switches which have moveable structures supported at one end and are free at another. In contrast, strap-based MEMS switches include moveable beams supported at opposing ends. A third class of MEMS switches is diaphragm-based structures in which a membrane is supported around most or all of its perimeter. The support structures of plate-based MEMS switches differ from support structures used for cantilever-based, strap-based and diaphragm-based MEMS switches in that they include arms laterally extending from the periphery of the plate to support structures spaced apart from the plate. The arms include a different shape than the moveable plate and are configured to twist and bend such that the entire plate may move up and down relative to the actuation of the switch.

As shown in FIGS. 1a and 1b, plate-based MEMS switch 20 includes support arms 36 spaced about the periphery of moveable plate 22 and extending to support vias 38. In the interest to simplify the distinction between moveable plate 22 and support arms 36, the structure of moveable plate 22 as referred to herein may generally refer to the components suspended between but not including support arms 36. As discussed in more detail below, although moveable plate 22 includes a plurality of components and, therefore, includes a plurality of materials, support arms 36 may, in some embodiments, include the same material as portions of moveable plate 22. As such, support arms 36 may be contiguous extensions of outer edge portions of moveable plate 22 in some embodiments. Consequently, different cross-hatched patterns are not used to differentiate the components. Dotted lines, however, are used in FIG. 1b to indicate the approximate location at which support arms 36 extend from moveable plate 22. The dotted lines are merely used to illustrate the relative position of the components and, therefore, are not part of MEMS switch 20. In some embodiments, support arms 36 may include different materials than outer edge portions of moveable plate 22 and, therefore, MEMS switch 20 is not necessarily restricted to the illustration in FIGS. 1a, 1b, and 2.

Although support arms 36 in FIGS. 1a and 2 are shown uniformly spaced about the periphery of moveable plate 22, the support arms may be arranged along any peripheral location of the moveable electrode. In some embodiments, however, it may be advantageous to space support arms 36 uniformly about moveable plate 22. In particular, uniformly spaced support arms may allow moveable plate 22 to be uniformly supported such that peripheral regions of moveable plate 22 may not be more susceptible to bending or collapsing onto fixed electrode 40 versus other peripheral regions of the electrode. In any case, although MEMS switch 20 is shown to include three support arms in FIGS. 1a and 2, MEMS switch 20 may include any plurality of support arms. In some embodiments, however, it may be advantageous for MEMS switch 20 to include a multiple of three support arms to provide structural stability to the moveable electrode. In particular, multiples of three support arms uniformly spaced around the periphery of moveable plate 22 may advantageously act as a tripod, defining a plane by which the plate is held and moved, thereby stabilizing moveable plate 22 both laterally and vertically relative to underlying components. Additional support arms in multiples of three may provide further support to such a tripod structure. As such, MEMS switch 20 may include, for example, six or nine support arms spaced about the periphery of moveable plate 22 in some embodiments.

In some cases, however, having more than three support arms may cause an uneven distribution of force on underlying contact structures when MEMS switch 20 is actuated. In particular, the slightest variation in the height of support vias 38 when more than three support arms are used within MEMS switch 20 may cause moveable plate 22 to warp or bend in order to be supported by all of the support arms. Warpage may undesirably increase the likelihood of moveable plate 22 coming into contact with fixed electrode 40, affecting the reliability of the switch. A switch with only three support arms, however, defines only one plane by which to support moveable plate 22 and, therefore, can afford to have variations of height within support vias 38 without causing an uneven distribution of force on the underlying contact structures. As such, in some embodiments, it may be advantageous to limit the number of support arms extending from moveable plate 22 to three.

In addition to maintaining moveable plate 22 at fixed locations both laterally and vertically relative to underlying components in the off and on states, support arms 36 may serve to pull moveable plate 22 out of contact with underlying contact structures when an actuation voltage is released. In particular, support arms 36 may, in some embodiments, be dimensioned such that moveable plate 22 does not collapse upon fixed electrode 40 and reliably opens when an actuation voltage is released. Parameters which may affect such functions of MEMS switch 20 include lengths, widths, thicknesses, shapes, and layout configurations of support arms 36, which may in turn depend on the design characteristics of other components within MEMS switch 20, such as the dimensions of moveable plate 22, for example. As such, support arms 36 may include a variety of lengths, widths, thicknesses, shapes and layout configurations and, therefore, are not necessarily restricted to those shown in FIGS. 1a, 1b, and 2. Exemplary configurations of lengths, widths, thicknesses, shapes, and layout configurations which may be used for support arms of plate-based MEMS switches, such as the ones described herein, are shown and described in U.S. patent application Ser. No. 10/921,746 which was filed on Aug. 19, 2004 and is incorporated by reference as if fully set forth herein.

Moreover, the size, shape, layout configuration of moveable plate 22 may vary, depending on the design specifications of the plate-based MEMS switch. Consequently, although FIGS. 1a and 2 illustrate moveable plate 22 having a circular configuration, moveable plate 22 is not restricted to such a shape. In fact, moveable plate 22 may include any shape. In some embodiments, it may be particularly advantageous to have moveable plate 22 in a shape which may be divided into three regions having substantially similar shapes and areas. In particular, a shape which is divisible into three regions having substantially similar shapes and areas may be advantageous for arranging contact structures uniformly under the moveable electrode as described in more detail below. The MEMS switches described herein, however, are not necessarily restricted to having contact structures uniformly arranged.

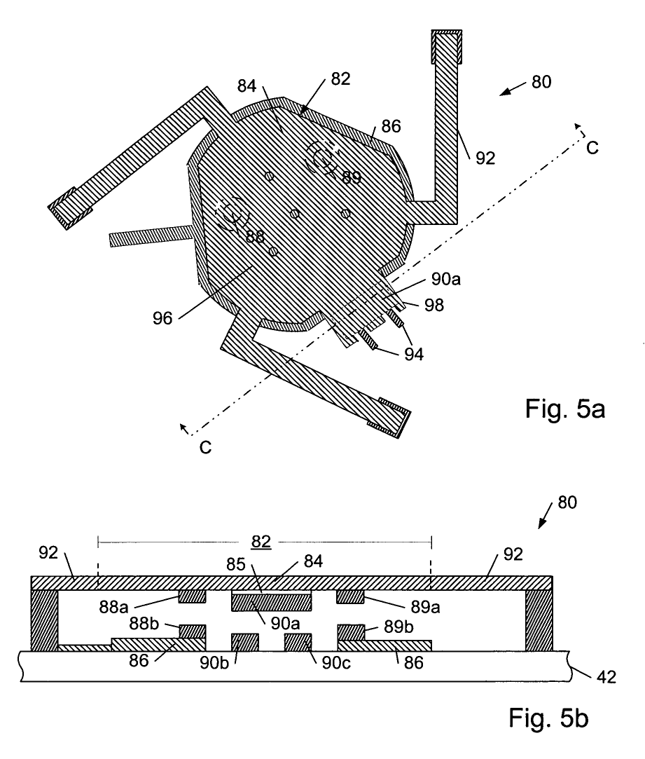

The circular configuration of moveable plate 22 illustrated in FIGS. 1a and 2 is a shape which may be divided into three symmetric regions, namely regions 46-48 as shown outlined by the dotted lines in FIG. 2. The dotted lines are merely used to illustrate a possible segregation of moveable plate 22 and, therefore, are not part of MEMS switch 20. Other shapes which may be divided into three symmetric regions may also be used for moveable plate 22. For example, moveable plate 22 may be triangular or a truncated circle, as shown for the MEMS switch embodiments in FIGS. 4a and 5a, respectively. Other exemplary shapes which may be divided into three symmetric regions and used for moveable plates of plate-based MEMS switches, such as the ones described herein, and the manner in which to define such regions relative to other components in the plate-based MEMS switch are described in U.S. patent application Ser. No. 10/921,746 which was filed on Aug. 19, 2004 and is incorporated by reference as if fully set forth herein.

In any case, the size of moveable plate 22 may be optimized to meet the design specifications of a switch, but may generally occupy an area between approximately 0.01 mm² and approximately 1.0 mm². In some embodiments, moveable plate 22 may include holes 54 as shown in FIGS. 1a and 2. Holes 54 are not shown in the cross-sectional view of MEMS switch 20 in FIG. 1b to simplify the drawing. The holes allow chemical access to the underside of moveable plate 22 during fabrication as well as allow air to escape during actuation. Moveable plate 22 may include any number of holes of any size and the holes may be arranged in any manner. Consequently, the number, size, and arrangement of holes 54 in moveable plate 22 are not restricted to the configuration shown in FIGS. 1 a and 2.

As noted above, moveable plate 22 may include a plurality of components. In particular, moveable plate 22 may include insulating member 25 interposed between conductive members 24 and 26 as shown in FIGS. 1a, 1b and 2. In addition, moveable plate 22 may include moveable electrode 28, input/output signal contact structure 30a, and other contact structures 32a and 34a. As shown in FIG. 1b, moveable electrode 28 is suspended below insulating member 25 and conductive members 24 over fixed electrode 40. Moveable electrode 28 is not shown in FIGS. 1a and 2 to simplify the illustrations of the drawings. In general, moveable electrode 28 may be configured in conjunction with fixed electrode 40 to open and close the switch upon the application and release of an actuation voltage along one or both of moveable electrode 28 and fixed electrode 40. More specifically, moveable electrode 28 and fixed electrode 40 may be coupled to high and low voltage potentials, respectively or vice versa, such that an application of high voltage potential along one or both of the components electrostatically draws moveable electrode 28 and, consequently, moveable plate 22 toward fixed electrode 40. In some cases, the low voltage potential may be ground and, therefore, voltage will be solely applied along the high voltage potential line. In other embodiments, the low voltage potential may be a relatively low voltage level.

In either case, the size of moveable electrode 28 and fixed electrode 40 may affect the operation of MEMS switch 20. For example, having moveable electrode 28 cover a relatively large area will induce greater contact force on underlying contact structures. A greater contact force may advantageously break through contamination on the contact structures, reducing contact resistance and stiction. Stiction refers to various forces tending to make two surfaces stick together such as van der Waals forces, surface tension caused by moisture between the surfaces, and/or bonding between the surfaces (e.g., through metallic diffusion). To open a mechanical switch, these forces need to be counteracted and, therefore, it is advantageous to lessen the forces when possible. On the other hand, larger areal dimensions of moveable electrodes produce larger devices, which is contrary to the industry objective to produce smaller components. As such, there is a trade-off in sizing moveable electrode 28.

As shown in FIG. 1b, MEMS switch 20 may include contact structures having portions extending into the space between fixed electrode 40 and moveable plate 22, as shown by contact structures 32a and 32b (collectively referenced as contact structure 32 in FIG. 1a) and contact structures 34a and 34b (collectively referenced as contact structure 34 in FIG. 1a). The number, arrangement and characteristics of such contact structures may vary as described in more detail below. In general, however, contact structures 32a, 32b, 34a and 34b serve to inhibit moveable electrode 28 from contacting fixed electrode 40 during actuation of MEMS switch 20. Although input/output signal contact structures 30a and 30b (collectively referenced as contact structure 30 in FIG. 1a) may also inhibit moveable electrode 28 from contacting fixed electrode 40 during actuation of MEMS switch 20, the input/output signal contact structures are also used to pass and receive current between input and output signal traces within the switch. In particular, input/output signal contact structures 30a and 30b are configured to receive and pass current between an input/output trace within moveable plate 22 and input/output signal trace 50 coupled to input/output contact structure 30b. More specifically, upon actuation of MEMS switch 20, moveable plate 22 moves toward substrate 42 such that input/output contact structures 30a and 30b join to complete a signal circuit between an input/output trace within moveable plate 22 and signal trace 50. Consequently, MEMS switch 20 may be a single point contact switch in some cases.

As shown in FIGS. 1a, 1b and 2, input/output signal contact structure 30a is coupled to conductive member 26 which in turn is coupled to one of support arms 36. In such embodiments, the support arm coupled to input/output signal contact structure 30a may include an input/output signal trace. In other embodiments, input/output signal contact structure 30a may not be coupled to one of the support arms of the switch. In particular, conductive member 26 may not be coupled to one of the support arms or conductive member 26 may be omitted from MEMS switch 20. In such cases, MEMS switch 20 may be configured as a dual point contact switch having input and output traces formed upon substrate 42 and connected upon actuation of MEMS switch 20 by input/output signal contact structure 30a. Exemplary embodiments of dual point contact MEMS switches having moveable plates with input/output signal contact structures not coupled to support arms are shown in FIGS. 4a and 5a and described in more detail below.

In any case, input/output signal contact structure 30a is electrically isolated from moveable electrode 28 such that a signal transmitted through MEMS switch 20, and more specifically through input/output signal contact structure 30a, is independent of the voltage potential used to close the switch. In particular, FIG. 1b illustrates moveable electrode 28 disposed below both conductive member 24 and insulating member 25 while input/output signal contact structure 30a is disposed below conductive member 26 spaced apart from moveable electrode 28, thereby electrically isolating input/output signal contact structure 30a from moveable electrode 28. Such a configuration allows moveable electrode 28 to be spaced apart from input/output signal contact structure 30a by an air gap. Other plate-based MEMS switches having exemplary configurations for electrically isolating input/output signal contact structures from moveable electrodes are shown in FIGS. 4a and 5a and described in more detail below.

FIGS. 1a and 2 illustrate conductive member 24 coupled to two of support arms 36, one or both of which may be coupled to either high or low voltage potential, depending on the operation specifications of the switch with respect to fixed electrode 40 as described above. Fixed electrode 40 is coupled to actuation line 44 having the opposite voltage potential as the support arms coupled to conductive member 24. Although FIGS. 1a and 2 illustrate conductive member 24 coupled to two of support arms 36, conductive member 24 may be coupled to any number of the support arms not coupled to input/output signal contact structure 30a, including one or all of the support arms. As such, one or more support arms may not, in some embodiments, be coupled to conductive members of moveable electrode 22. Support arms not coupled to conductive members of moveable plate 22 and/or not coupled to a high or low voltage potential may be referred to herein as “electrically inactive.”

In general, the areal dimensions and layout configuration of conductive members 24 and 26 and insulating member 25 may depend on the placement of moveable electrode 28 and input/output signal contact structure 30a. In addition, the areal dimensions of moveable electrode 28 may generally depend on the areal dimensions of fixed electrode 40, the number of contact structures interposed between the moveable electrode and the fixed electrode, and the actuation voltage used to operate the switch. As such, although conductive members 24 and 26 are shown bordering the edge of moveable plate 22 and insulating member 25 is shown spanning a majority width of the plate, the size and arrangement of such components are not necessarily so restricted. In fact, conductive members 24 and 26 and insulating member 25 may be sized and arranged in any manner in which to effectively isolate input/output signal contact structure 30a from moveable electrode 28.

As noted above, contact structures 32 and 34 and input/output signal contact structure 30 serve to inhibit moveable electrode 28 from contacting fixed electrode 40 during actuation of MEMS switch 20. In general, MEMS switch 20 may include any number of contact structures between moveable plate 22 and fixed electrode 40. In some embodiments, however, it may be advantageous to provide at least three contact structures therebetween and may, in some cases, be further advantageous to limit the number of contact structures to three. In particular, three contact structures may form a plane upon which moveable plate 22 may be uniformly supported, thereby preventing moveable plate 22 from warping, bending, or collapsing onto fixed electrode 40. In any case, contact structures 30, 32, and 34 may be arranged at any positions between moveable plate 22 and fixed electrode 40 such that input/output contact structure 30a is isolated from moveable electrode 28. Exemplary positions and quantities of contact structures to be included in plate-based MEMS switches, such as the ones described herein, are described in U.S. patent application Ser. No. 10/921,746 which was filed on Aug. 19, 2004 and is incorporated by reference as if fully set forth herein.

In some embodiments, it may be advantageous to position contact structures 30, 32, and 34 away from a center point of moveable plate 22. In particular, one or more contact structures arranged very close to a center of a moveable plate may cause portions of the plate to bend or collapse onto the underlying fixed electrode. In addition, positioning contact structures closer to the edge of moveable plate 22 may induce greater contact forces relative to positions closer to a central axis of the moveable plate when an actuation voltage is applied. As noted above, greater contact forces may be advantageous for breaking through contamination on the contact structures to reduce the stiction between the structures. As such, contact structures 30, 32, and 34 closer to the edges of moveable plate 22 may advantageously increase the force on the contact structures without having to increase the actuation voltage to operate MEMS switch 20.

Moreover, in some embodiments, it may be advantageous to distribute contact structures 30, 32 and 34 across the region spanned by moveable plate 22 in order to provide a plane on which to evenly support moveable plate 22. For example, in some embodiments, contact structures 30, 32 and 34 may each be arranged within one of regions 46-48 as shown in FIG. 2. In other embodiments, two or more of contact structures 30, 32 and 34 may be arranged in the same regions. Regardless of whether contact structures 30, 32 and 34 are each arranged within regions 46-48, the contact structures may be arranged either uniformly or non-uniformly relative to each other's position in their respective regions. In some embodiments, it may be advantageous to arrange the contact structures non-uniformly among the regions such that a variation of contact force is induced among the contact structures. The variation of force among the contact structures may allow the release of contact structures at different times and, in some cases, the release of one contact structure may allow a greater force to open the other contact structures, improving the opening reliability of the switch.

As shown in FIG. 1b, contact structures 30, 32, and 34 include contact structures 30a, 32a, and 34a formed directly beneath moveable plate 22 and further include contact sub-structures 30b, 32b, and 34b formed upon substrate 42. In this manner, each of contact structures 30, 32, and 34 may include a set of contact sub-structures. In other embodiments, one or more of contact structures 30, 32 and 34 may only include one contact structure formed upon substrate 42 or formed within moveable electrode 22. More specifically, one or more of contact structures 30a, 32a, 32b, 34a, and 34b may be omitted from MEMS switch 20. As such, contact structures 32a and/or 34a may, in some embodiments, come into direct contact with fixed electrode 40 or substrate 42, depending on whether the contact structures comprise dielectric materials or conductive materials, respectively. In addition or alternatively, moveable plate 22 may, in some embodiments, come into direct contact with contact structures 30b, 32b, and/or 34b. In such cases, although the physical structures shown for contact structures 30a, 32a, and 34a in FIG. 1a may be omitted from MEMS switch 20, portions of moveable plate 22 contacting lower contact structures 30b, 32b, and/or 34b may be characterized as contact structures. Consequently, moveable plate 22 may still be referenced as including contact structures.

In any case, at least one of contact structures 30a, 30b, 32a, 32b, 34a, and 34b may be dimensioned to extend into the space between fixed electrode 40 and moveable plate 22. In this manner, moveable plate 22 may be prevented from coming into contact with fixed electrode 40 when an actuation voltage is applied. In some cases, one or more of contact structures 30a, 30b, 32a, 32b, 34a, and 34b may have a different thickness than the others. In yet other embodiments, contact structures 30a, 30b, 32a, 32b, 34a, and 34b may have substantially similar thicknesses. In addition, contact structures 30a, 30b, 32a, 32b, 34a, and 34b may, in some embodiments, have substantially similar lateral dimensions such that the structures are of similar shape and/or size. In yet other embodiments, one or more of contact structures 30a, 30b, 32a, 32b, 34a, and 34b may be of different shapes and/or sizes. In either case, any of contact structures 30a, 32a, 34a, 30b, 32b, and 34b may include more than one contact features or bumps. In addition, contact structures 32a and 34a, and/or 32b and 34b may, in some embodiments, be wired in parallel to reduce the combined resistance.

As shown in FIG. 3a, contact structures 32b and 34b may be formed upon substrate 42 isolated from fixed electrode 40. In such cases, contact structures 32b and 34b may characterized as “electrically isolated contact structures” since they are not used to draw current, such as to draw moveable electrode 28 downward or pass an input/output signal through MEMS switch 20. In alternative embodiments, one or both of contact structures 32b and 34b may be coupled to signal wires 52 as shown in FIG. 3b. As noted above, contact structures which are coupled to signal wires which in turn are coupled to input/output terminals may be referred to as “input/output signal contact structures.” Consequently, in embodiments in which signal wires 52 are coupled to input/output terminals, contact structures 32 and 34 may be input/output signal contact structures. In such cases, contact structures 32 and 34 may be characterized as “electrically active” contact structures. In contrast, in embodiments in which contact structures 32 and 34 are coupled to signal wires which are not coupled to signal input or output terminals, contact structures 32 and 34 may be referred to as “electrically inactive” contact structures. In yet other embodiments, one or both of contact structures 32b and 34b may be formed upon fixed electrode 40. In such cases, contact structures 32 and/or 34 may include either conductive or dielectric materials and, therefore, may be referred to as electrically active or inactive.

In some embodiments, one or all of contact structures 30, 32 and 34 may include different materials than each other. Such a variation of materials may be particularly advantageous for contact structures which are electrically inactive such that the speed at which the MEMS switch is operated is not affected. For example, in embodiments in which contact structures 32 and 34 are not coupled to an RF signal input/output terminal, contact structures 32 and 34 may include materials which are less susceptible to stiction than a material used for input/output signal contact structure 30. For example, in some embodiments, contact structures 32 and 34 may include rhodium or osmium and input/output signal contact structure 30 may include gold. Other material configurations for the contact structures may also be used for MEMS switches, depending on the design specifications of the switch. Fabricating one or more contact structures with a material which is less susceptible to stiction may advantageously allow the switch to open more easily since a lower restoring force will be needed to open the contact structure with such a material. In addition, material variations among contact structures may allow the contact structures to be opened at different times, which, as noted above, may improve the opening reliability of the switch.

In any case, input/output signal contact structure 30 may include a conductive material such that a signal may be transmitted therethrough. For example, input/output signal contact structure 30 may include gold, chromium, copper, tantalum, titanium, tungsten, rhodium, ruthenium, or alloys of such metals. Since contact structures 32 and/or 34 may be configured to be electrically active or inactive, depending on the design specifications of the switch, the contact structures may include conductive or non-conductive materials. In particular, contact structures 32 and/or 34 may include any of the materials listed for input/output signal contact structure 30 or may include a dielectric material, such as but not limited to silicon dioxide (SiO₂), silicon nitride (SiₓN_{y}), silicon oxynitride (SiOₓN_{y}(H_{z})), or silicon dioxide/silicon nitride/silicon dioxide (ONO). In some embodiments, contact structures 32 and/or 34 may include a combination of conductive and dielectric materials. For example, contact structures 32 and/or 34 may include a dielectric cap layer arranged upon the conductive material.

As shown in FIGS. 3a and 3b, fixed electrode 40 may, in some embodiments, include cutout portions to isolate contact structures 30b, 32b, and 34b and any signal wires coupled thereto. In particular, fixed electrode 40 may include cutout portions 56 and 58 having configurations which follow the contour contact structures 32b and 34b and contact structure 30b and signal wire 50, respectively, as shown in FIG. 3a. More specifically, fixed electrode 40 may be configured to have cutout portions with edges which are spaced a substantially uniform distance from signal wire 50 and contact structures 30b, 32b, and 34b. In other embodiments, fixed electrode 40 may be configured with cutout portions with edges which are not spaced a uniform distance around signal wires and contact structures. For example, fixed electrode 40 may include cutout portion 62 spanning across a relatively large region of substrate 42 as shown in FIG. 3b.

In some embodiments, cutout portion 62 may serve to reduce the capacitive coupling between contact structure 30b and signal wire 50 and fixed electrode 40 as well as between fixed electrode 40 and overlying conductive member 26 without changing the vertical spacing of moveable plate 22 to fixed electrode and the underlying contact structures. As noted above, off-state energy leakage sometimes occurs in MEMS switches due to capacitive coupling between components in close proximity to each other. As such, reducing the capacitive coupling between signal lines and adjacent conductive structures (i.e., increasing the lateral spacing between such components) may advantageously improve the reliability of a switch. In some embodiments, cutout portion 62 may emulate the area occupied by conductive member 26 as shown in FIG. 3b. In other embodiments, larger or smaller regions and/or regions of different shapes may be used to isolate contact structure 30b and signal wire 50 from fixed electrode 40.

In some embodiments, it may be advantageous to increase the area by which a cutout portion extends to inhibit portions of an overlying moveable electrode which are particularly susceptible to collapsing to come into contact with fixed electrode 40. A disadvantage of enlarging the cutout portions of a fixed electrode, however, is that a larger actuation voltage may be needed to bring a moveable electrode 28 down in contact with contact structures 30b, 32b, and/or 34b for a given amount of contact force. In some cases, increasing the actuation voltage of a switch may undesirably increase the force attracting the electrodes of a MEMS switch to be high enough to cause the electrodes to contact, negating the benefit of the enlarge cutout portions. As such, there is a trade-off in sizing cutout portions within fixed electrode 40.

In general, fixed electrode 40 may be configured to have any size and shape of cutout portions around signal wires 50 and 52 and contact structures 30b, 32b, and 34b, including larger and smaller spaces extending from one or both sides of signal wires 50 and 52 as well as from portions of contact structures 30b, 32b, and 34b as compared to the configurations shown in FIGS. 3a and 3b. In addition, fixed electrode 40 may additionally or alternatively include additional cutout-portions. In other embodiments, fixed electrode 40 may be segmented into two or more electrodes. Consequently, the configuration of the fixed electrode 40 is not restricted to the configurations shown in FIGS. 3a and 3b. Exemplary configurations of cutout portions which may be included in a fixed electrode of a plate-based MEMS switch, such as the ones provided herein, are shown and described in U.S. patent application Ser. No 10/921,746 which was filed on Aug. 19, 2004, which is incorporated by reference as if fully set forth herein. In addition or alternative to fixed electrode 40, moveable plate 22 may include cutout portions. Exemplary configurations of cutout portions which may be included in a moveable plate of a MEMS switch, such as the ones provided herein, are shown and described in U.S. patent application Ser. No 10/921,696 filed on Aug. 19, 2004, which is incorporated by reference as if fully set forth herein.

Regardless of the size of cutout portions within fixed electrode 40 and/or moveable plate 22, the shape of fixed electrode 40 may be substantially similar to the shape of moveable plate 22 in some embodiments, as shown in FIG. 1a. Having a shape similar to moveable plate 22 may advantageously reduce the area occupied by MEMS switch 20. In yet other cases, the shape of fixed electrode 40 may have a substantially different shape than moveable plate 22. In any case, FIG. 1a illustrates fixed electrode 40 as having a larger width than moveable plate 22. Such a configuration may be particularly advantageous when fabricating MEMS switch 20 with conformal deposition techniques. In particular, fabricating moveable plate 22 to have a smaller width than fixed electrode 40 may advantageously allow moveable plate 22 to be formed without a peripheral lip. In yet other embodiments, however, fixed electrode 40 may be formed to have substantially similar or smaller dimensions than moveable plate 22. In any case, the widths of fixed electrode and moveable plate 22 may generally be between approximately 100 microns and approximately 1000 microns.

An alternative plate-based MEMS switch is shown in FIGS. 4a and 4b. In particular, FIGS. 4a and 4b illustrate MEMS switch 60 including a dual point contact switch having components used to induce mechanical action of the switch which are electrically isolated from components of the switch used for the transmission of signals. More specifically, MEMS switch 60 includes moveable plate 62 including input/output signal contact structure 70a electrically isolated from moveable electrode 64, which in conjunction with fixed electrode 66 is configured to cycle the switch open and closed. FIG. 4a is a plan view of MEMS switch 60 and FIG. 4b is a cross-sectional view of MEMS switch 60 taken along line BB of FIG. 4a. As shown in FIG. 4b, input/output signal contact structure 70a is arranged directly over input/output signal contact structures 70b and 70c, which are formed upon substrate 42 isolated from fixed electrode 66. Input/output signal contact structures 70b and 70c are respectively coupled to signal wires 74, which in turn may be coupled to input/output terminals. Upon actuation of moveable electrode 64 or fixed electrode 66, moveable plate 62 moves toward substrate 42 such that input/output signal contact structure 70a contacts input/output signal contact structures 70b and 70c to complete a signal circuit. Such movement may also bring moveable plate 62 in contact with contact structure 68 formed upon substrate 42 to prevent moveable electrode 64 from shorting with fixed electrode 66.

In addition to offering a dual point contact switch configuration, MEMS switch 60 offers a different manner of isolating an input/output contact structure from a moveable electrode within a suspended plate. In particular, moveable plate 62 includes insulating member 65 interposed between portions of moveable electrode 64 rather than suspending the moveable electrode below the insulating member as in MEMS switch 20 of FIGS. 1a and 1b. Consequently, moveable electrode 64 and input/output signal contact structure 70a are not formed within the same plane. More specifically, moveable electrode 64 extends directly from support arms 72 and, therefore, within the plane thereof, while input/output signal contact structure 70a is positioned slightly below such a plane by the thickness of insulating member 65. In some embodiments, MEMS switch 20 of FIGS. 1a and 1b may include such an alternative configuration. In addition, MEMS switch 60 may alternatively include a configuration similar to MEMS switch 20 having a moveable electrode and an input/output signal contact structure arranged within approximately the same plane.

As shown in FIGS. 4a and 4b, MEMS switch 60 illustrates other variations of component arrangements and configurations as compared to the illustration of MEMS switch 20 in FIGS. 1a and 1b. For example, movable plate 62 and fixed electrode 66 are triangular in shape. MEMS switch 60, however, is not necessarily restricted to illustrations in FIGS. 4a and 4b. In particular, the components included within MEMS switch 60 may include any of the variations described for similar components within MEMS switch 20. For example, although moveable plate 62 and fixed electrode 66 are shown as triangular in shape, one or both of the components may include different shape. In addition, MEMS switch 60 may include any number and arrangement of support arms and contact structures. In some embodiments, MEMS switch 60 may alternatively be configured as a single point contact switch. In particular, input/output signal contact structure 70a may alternatively be coupled to one of support arms 72, which in turn may include an input/output signal trace. In any case, the components within MEMS switch 60 may include any of the materials and dimensions described for the components of MEMS switch 20 in reference to FIGS. 1a-3b.

Another alternative configuration of a plate-based MEMS switch is shown in FIGS. 5a and 5b and includes moveable plate 82 with input/output signal contact structure 90a electrically isolated from moveable electrode 84, which in conjunction with fixed electrode 86 is configured to cycle the switch open and closed. FIG. 5a is a plan view of MEMS switch 80 and FIG. 5b is a cross-sectional view of MEMS switch 80 taken along line CC of FIG. 5a. Similar to MEMS switch 60 in FIGS. 4a and 4b, FIGS. 5a and 5b illustrate MEMS switch 80 as a dual point contact switch. More specifically, MEMS switch 80 includes input/output signal contact structure 90a arranged directly over input/output signal contact structures 90b and 90c, which are formed upon substrate 42 isolated from fixed electrode 86. Input/output signal contact structures 90b and 90c are respectively coupled to signal wires 94, which in turn may be coupled to input/output terminals. Upon actuation of moveable electrode 84 or fixed electrode 86, moveable plate 84 moves toward substrate 42 such that input/output signal contact structure 90a contacts input/output signal contact structures 90b and 90c to complete a signal circuit. Such movement may also bring contact structures 88a and 89a in contact with contact structures 88b and 89b to prevent moveable electrode 84 from shorting with fixed electrode 86.

As with MEMS switch 60 in FIGS. 4a and 4b, MEMS switch 80 illustrates other variations of component arrangements and configurations as compared to the illustration of MEMS switch 20 in FIGS. 1a and 1b. MEMS switch 80, however, is not necessarily so restricted. In particular, the components included within MEMS switch 80 may include any of the variations described for similar components within MEMS switch 20 or MEMS switch 60. For example, although moveable plate 82 and fixed electrode 86 are shown as truncated circles (and moveable plate 82 further includes extension 98 as described in more detail below), one or both of the components may include different shapes with or without extensions. In addition, MEMS switch 80 may include any number and arrangement of support arms and contact structures. In some embodiments, MEMS switch 80 may alternatively be configured as a single point contact switch. In particular, input/output signal contact structure 90a may alternatively be coupled to one of support arms 92, which in turn may include an input/output signal trace. In any case, the components within MEMS switch 80 may include any of the materials and dimensions described for the components of MEMS switch 20 in reference to FIGS. 1a-3b and/or any of the materials and dimensions described for the components of MEMS switch 60 in reference to FIGS. 4a and 4b.

A further distinction of MEMS switch 80 versus MEMS switches 20 and 60 is the manner in which input/output contact structure 90a is isolated from moveable electrode 84 within moveable plate 82. In particular, moveable plate 82 includes insulating member 85 vertically interposed between moveable electrode 84 and input/output contact structure 90a rather than suspending the moveable electrode below the insulating member as in MEMS switch 20 of FIGS. 1a and 1b or laterally interposing the insulating member between portions of the moveable electrode as in MEMS switch 60 of FIGS. 4a and 4b. In this manner, moveable electrode 84 may extend as a contiguous material from support arms 92. In some embodiments, MEMS switch 20 of FIGS. 1a and 1b and/or MEMS switch 60 of FIGS. 4a and 4b may alternatively include such a configuration. In addition, MEMS switch 80 may alternatively include a configuration similar to MEMS switch 20 or 60. In particular, MEMS switch 80 may include an insulating member arranged above a moveable electrode and an input/output signal contact structure or, alternatively, an insulating member laterally interposed between portions of a moveable electrode.

In addition to providing an alternative manner in which to isolate input/output contact structure 90a from moveable electrode 84, MEMS switch 80 includes a different configuration for a moveable plate as compared to the descriptions provided in reference to MEMS switches 20 and 60. In particular, movable plate 82 includes extension 98 projecting from main portion 96. In general, main portion 96 may be substantially similar to moveable plates 22 and 62 discussed in reference to FIGS. 1a and 4a. In particular, main portion 98 may have any shape, including but not limited to circular, triangular and rectangular. In addition, main portion 98 may have support arms spaced about its periphery and have holes from which to allow air to pass. As shown in FIG. 5a, fixed electrode 86 spaced below moveable electrode 82 may, in some cases, have a shape substantially similar to main portion 96. In other embodiments, however, fixed electrode 86 may include a shape which is substantially similar to main portion 96 and extension 98 combined.

In any case, although extension 98 is shown at an angular location which bisects the angular locations of two of support arms 92, extension 98 may be positioned at any angular location along the periphery of main portion 96. In addition, extension 98 may include any shape and any number of segments. For example, extension 98 may be rectangular as shown in FIG. 5a or, alternatively, may be circular, triangular, or square. Furthermore, extension 98 may include additional segments. For example, in some embodiments, extension 98 may include one or more additional segments extending from the edge of extension 98 shown in FIG. 5a. In addition or alternatively, moveable electrode 82 may include one or more additional extensions. As shown in FIG. 5a, input/output signal contact structure 90a may be arranged at extension 98. Input/output signal contact structure 90a, however, may be arranged at any location of moveable plate 82 as long as it is isolated from moveable electrode 84. In addition, one or both of contact structures 88 and 89 may alternatively be arranged along extension 98. Furthermore, MEMS switches 20 and 60 may include extensions in some embodiments.

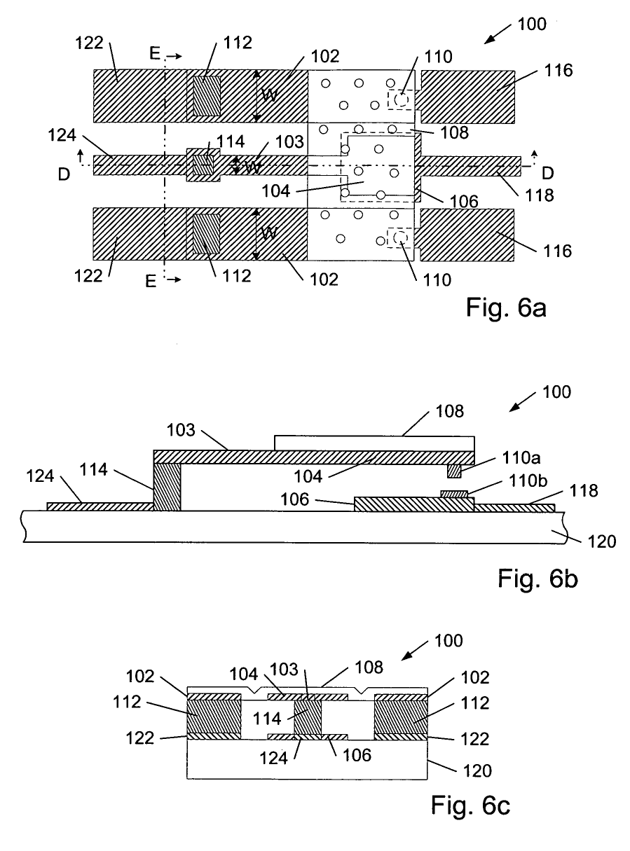

Exemplary configurations of cantilever-based MEMS switches having mechanically active components which are electrically isolated from components of the switch used for the transmission of signals are illustrated in FIGS. 6a- 10c. In particular, FIGS. 6a-6c illustrate MEMS switch 100 with cantilevered input/output signal lines 102 electrically isolated from cantilevered electrode 104, which in conjunction with fixed electrode 106 is configured to cycle the switch open and closed. In addition, MEMS switch 100 includes insulating member 108 connecting cantilevered input/output signal lines 102 and cantilevered electrode 104 such that upon actuation of cantilevered electrode 104 or fixed electrode 106, cantilevered input/output signal lines 102 and cantilevered electrode 104 will together move toward substrate 120. FIG. 6a is a plan view of MEMS switch 100, FIG. 6b is a cross-sectional view of MEMS switch 100 taken along line DD of FIG. 6a, and FIG. 6c is a cross-sectional view of MEMS switch 100 taken along line EE of FIG. 6a.

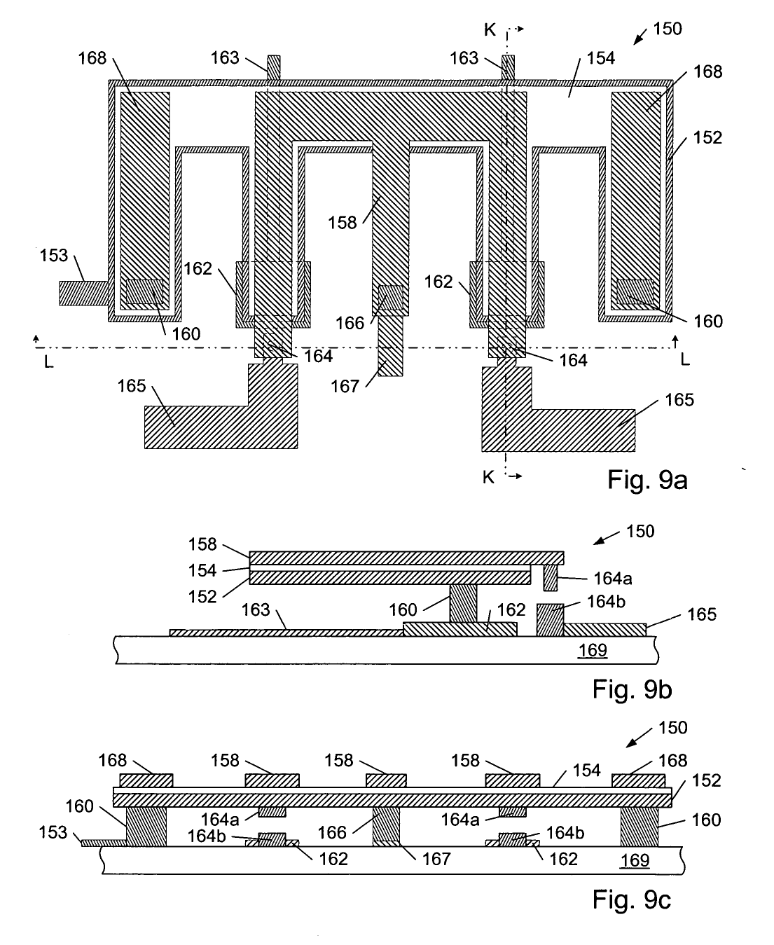

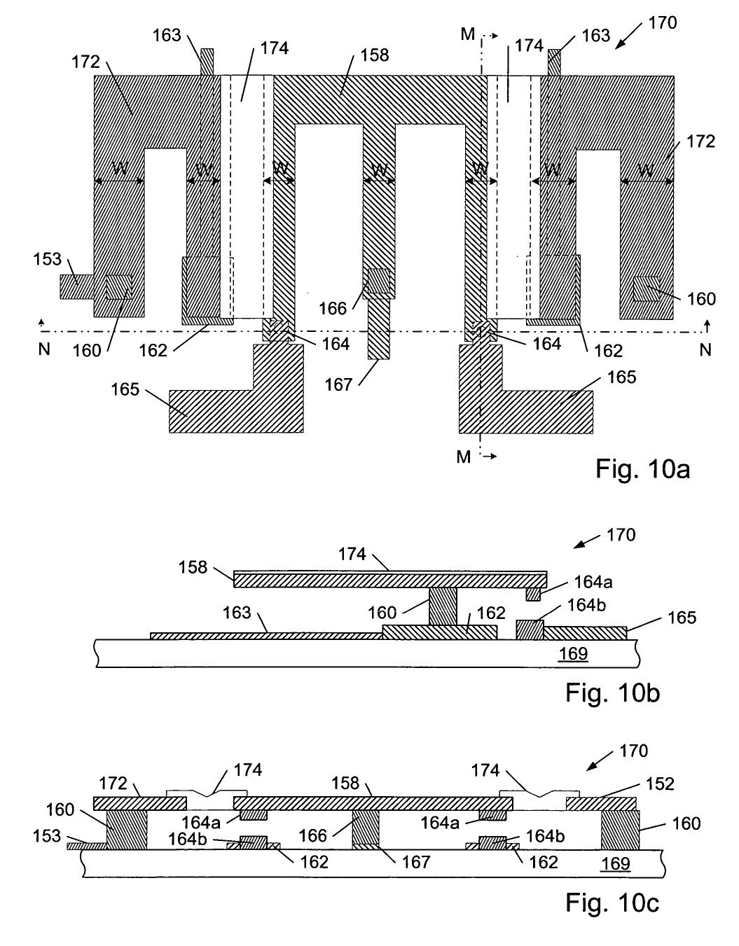

As shown in FIGS. 6a-6c, cantilevered input/output signal lines 102 and cantilevered electrode 104 are supported at one end by support structures 112 and 114 and are suspended at opposing ends over input/out signal contact structures 110 and fixed electrode 106, respectively. In this manner, cantilevered input/output signal lines 102 and cantilevered electrode 104 may be referred to as cantilevered beams. As used herein, the term “cantilever beam” may refer to a structure having a substantially straight plan profile with one end anchored to an underlying substrate and an opposing free end suspended above the substrate. The term “cantilevered structure,” on the other hand, may more broadly refer to a structure having an end anchored to an underlying substrate and a free suspended above the substrate, regardless of whether the plan view of the structure includes curves, bends, or is substantially straight. Exemplary configurations of cantilevered structures with bending plan profiles are illustrated in FIGS. 9a-10c and described in more detail below.

In general, cantilevered electrode 104 may be configured in conjunction with fixed electrode 106 to open and close the switch upon the application and release of an actuation voltage along one or both of lines 103 and 118 coupled to the respective electrodes. More specifically, lines 118 and 124 may be coupled to high and low voltage potentials, respectively or vice versa, such that an application of high voltage potential along one or both of the components electrostatically draws cantilevered electrode 104 and, consequently, cantilevered input/output signal lines 102 toward fixed electrode 106 and input/out signal contact structures 110, respectively. As shown in FIG. 6a, insulating member 108, cantilevered input/output signal lines 102, and cantilevered electrode 104 may include holes to allow air to escape during actuation as well as to allow chemical access to the underside of the electrode during fabrication. The number, size, and arrangement of holes may vary depending on the design applications of MEMS switch 100 and, therefore, are not necessarily restricted to the configuration shown in FIG. 6a. The holes are not shown in the cross-sectional view of MEMS switch 100 in FIGS. 6b and 6c to simplify the drawings.

As shown in FIGS. 6a and 6b, input/out signal contact structures 110 includes input/out signal contact structure 110a coupled to the free end of cantilevered input/output signal lines 102 and input/out signal contact structure 110b coupled to signal traces 116. Although input/out signal contact structure 110a appears to extend from cantilevered electrode 104 and input/out signal contact structure 110b appears to be formed upon fixed electrode 106 in FIG. 6b, such structures are actually formed coupled to one of input/output signal lines 102 and signal traces 116, which are arranged behind cantilevered electrode 104 and fixed electrode 106. In general, input/out signal contact structures 110a and 110b are configured to complete signal circuits between cantilevered input/output signal traces 122 and signal traces 116 upon actuation of the switch. In particular, input/output signal contact structures 110a and 110b are configured to be a single point of contact for completing each of the signal circuits and, therefore, MEMS switch 100 is a single point contact switch.

In addition to completing signal circuits within MEMS switch 100, one of both of input/output signal contact structures 110 may serve to inhibit cantilevered electrode 104 from contacting fixed electrode 106 during actuation of MEMS switch 100. As such, one or both of input/output signal contact structures 110a and 110b may extend into the space under the cantilevered input/output signal lines 102. In addition or alternatively, MEMS switch 100 may include other contact structures which are configured to inhibit cantilevered electrode 104 from contacting fixed electrode 106 during actuation of the switch. In particular, MEMS switch 100 may include additional contact structures extending within the spaces under the cantilevered input/output signal lines 102 and/or under cantilevered 104, either coupled to such structures and/or upon substrate 120. The number and arrangement of such additional contact structures may vary, depending on the design characteristics of the device.

As noted above, MEMS switch 100 includes insulating member 108 connecting cantilevered input/output signal lines 102 and cantilevered electrode 104. As a consequence, input/output signal lines 102 are isolated from cantilevered electrode 104 and, thus, input/output signals transmitted through MEMS switch 100 are independent of the voltage potential used to close the switch. In some embodiments, insulating member 108 may include a stiffer material than included in cantilevered input/output signal lines 102 and/or cantilevered electrode 104. In this manner, the force to open switch 100 may be determined by the portions of cantilevered input/output signal lines 102 and cantilevered electrode 104 which do not overlap with the insulating member. In other embodiments, insulating member 108 may include a more elastic material than cantilevered input/output signal lines 102 and/or cantilevered electrode 104, provided that components of MEMS switch 100 are dimensioned to allow operation without unwanted side-to-side deformation of the aggregate cantilevered structure. In either case, although FIG. 6c shows insulating member 108 disposed between side portions of cantilevered input/output signal lines 102, cantilevered electrode 104, and line 103 as well as above such structures, MEMS switch 100 may alternatively have insulating member 108 exclusively disposed above the structures and above the spaces therebetween.

In addition, insulating member 108 may be configured to extend along any portions of cantilevered input/output signal lines 102, cantilevered electrode 104 and/or line 103, including all or partial portions of such structures. For example, insulating member 108 may, in some embodiments, be arranged along approximately half of cantilevered input/output signal lines 102 starting from its free end as shown in FIGS. 6a and 6b. In addition, insulating member 108 may be arranged along corresponding portions of cantilevered electrode 104 and portions of line 103. In other embodiments, insulating member 108 may extend along larger or smaller portions of cantilevered input/output signal lines 102, cantilevered electrode 104 and/or line 103. In addition, insulating member 108 may be spaced away from the free end of the cantilevered structures in some cases. In other words, cantilevered input/output signal lines 102 and cantilevered electrode 104 may, in some embodiments, extend out from insulating member 108. Furthermore, insulating member 108 does not necessarily need to extend to the outer edges of cantilevered input/output signal lines 102. Moreover, insulating member 108 does not necessarily need to be configured in a rectangular shape. In particular, insulating member 108 may include any shape and/or include any number of cut-outs or extensions. As such, insulating member 108 is not necessarily limited to the illustrations in FIGS. 6a-6c. In general, the thickness of insulating member 108 may be between approximately 0.1 micron and approximately 10 microns, but larger or smaller thicknesses may be employed.

A benefit of separating the transmission of input/output signals through MEMS switch 100 from the voltage potential used to close the switch is that cantilevered input/output signal lines 102 and line 103 may be independently sized to optimize electrical and mechanical properties of the switch, respectively. In particular, cantilevered input/output signal lines 102 may be configured with a width dimension that sufficiently matches impedance of the line with other components of the switch (i.e., impedance will be reduced relative to the increase of signal line width). In addition, line 103 may be configured with a width dimension that governs the elasticity in the line such that cantilevered electrode 104 does not come into contact with fixed electrode 106 but is sufficiently flexible for moving cantilevered electrode 104 such that contact between input/output signal lines 102 and contact structures 110 may be made upon actuation of the switch. Although line 103 is shown having a relatively smaller width than input/output signal lines 102 in FIG. 6a, MEMS switch 100 is not necessarily so restricted. In particular, line 103 may alternatively have the same width or a relatively larger width than input/output signal lines 102, depending on the design specifications of the switch, such as the lengths of the lines, for example.

The lengths of input/output signal lines 102 and line 103 may generally refer to the dimension of the components extending from support structures 112 and 114, respectively, to the free ends of the cantilevered structures. The widths of input/output signal lines 102 and line 103 may generally refer to the dimensions orthogonal to the length dimensions of such components as denoted in FIG. 6a with reference letter W. Exemplary widths for cantilevered input/output signal lines 102 and line 103 may generally be between approximately 10 microns and approximately 1000 microns. Exemplary lengths for cantilevered input/output signal lines 102 and line 103 may generally be between approximately 20 microns and approximately 5000 microns. Larger or smaller widths and/or lengths, however, may be employed for cantilevered input/output signal lines 102 and line 103, depending on the design specifications of the switch.

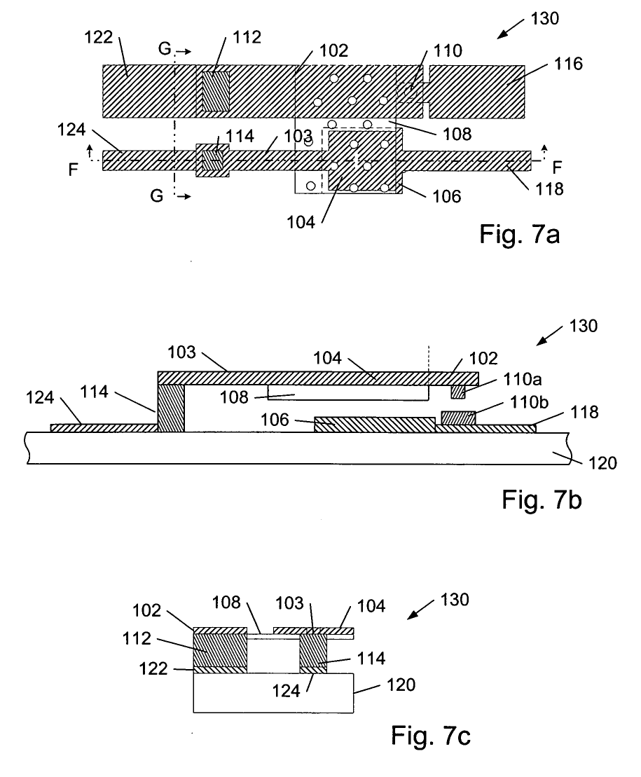

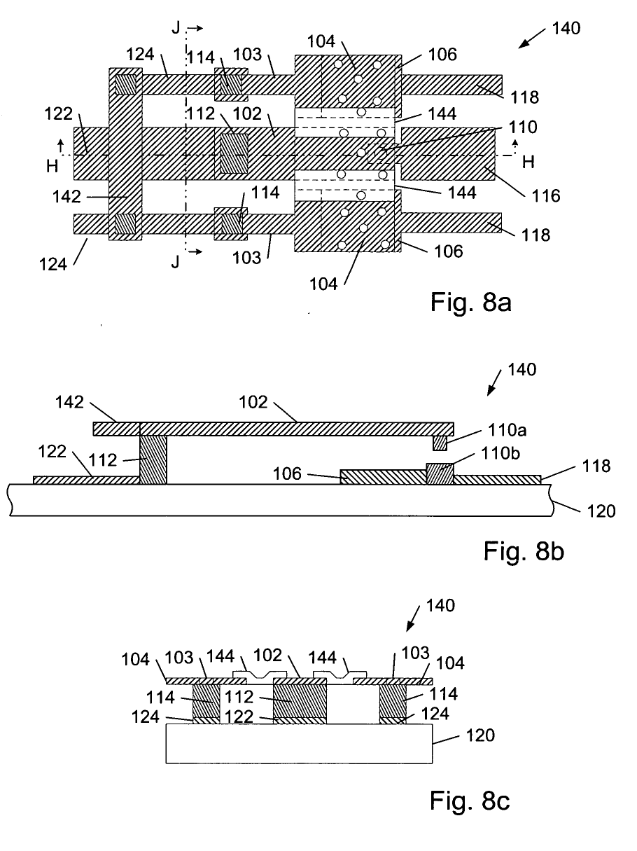

Although MEMS switch 100 is configured as a double-pole single-throw (DPST) switch, the cantilevered-based MEMS switches described herein are not necessarily so limited. In particular, the cantilever-based MEMS switches described herein may be configured for any number of poles and throws. Exemplary configurations of single-pole single throw (SPST) switches are shown in FIGS. 7a-8c. In particular, FIGS. 7a-7c illustrate MEMS switch 130 having only one signal circuit and one actuation circuit. The circuits may include substantially similar components as MEMS switch 100 described above in reference to FIGS. 6a-6c and, therefore, include several of the same reference numbers. FIG. 7a is a plan view of MEMS switch 130, FIG. 7b is a cross-sectional view of MEMS switch 130 taken along line FF of FIG. 7a, and FIG. 7c is a cross-sectional view of MEMS switch 130 taken along line GG of FIG. 7a.

In addition to only including one signal circuit, MEMS switch 130 differs from MEMS switch 100 by having insulating member 108 arranged below cantilevered input/output signal lines 102, cantilevered electrode 104 and line 103. Furthermore, the lengths of cantilevered input/output signal lines 102 and cantilevered electrode 104 differ. Consequently, a portion of cantilevered input/output signal lines 102 extends beyond cantilevered electrode 104 as shown by the dotted line in the cross-sectional view of FIG. 7b. It is noted that these two alternative configurations are not necessarily mutually exclusive nor are they specific to SPST MEMS switches. As such, MEMS switch 130 may alternatively have cantilevered input/output signal lines 102 and cantilevered electrode 104 extend substantially similar distances over substrate 120 and/or include insulating member 108 arranged above cantilevered input/output signal lines 102, cantilevered electrode 104 and line 103 as described in reference to MEMS switch 100. In addition, MEMS switch 100 of FIGS. 6a-6c may alternatively have cantilevered input/output signal lines 102 and cantilevered electrode 104 extend substantially different distances over substrate 120 and/or include insulating member 108 arranged below cantilevered input/output signal lines 102, cantilevered electrode 104 and line 103. In any of such cases, all characteristics of cantilevered input/output signal lines 102, cantilevered electrode 104, and insulating member 108 described above in reference to MEMS switch 100 may apply.

An alternative configuration of a SPST cantilever-based MEMS switch is shown in FIGS. 8a-8c. In particular, FIGS. 8a-8c illustrate MEMS switch 140 having a split actuation circuit and only one signal circuit. The components of MEMS switch 140 may be substantially similar to the components of MEMS switch 100 described above in reference to FIGS. 6a-6c and, therefore, include several of the same reference numbers. FIG. 8a is a plan view of MEMS switch 140, FIG. 8b is a cross-sectional view of MEMS switch 140 taken along line HH of FIG. 8a, and FIG. 8c is a cross-sectional view of MEMS switch 140 taken along line JJ of FIG. 8a. As shown in FIG. 8a, MEMS switch 140 differs from MEMS switch 130 by including two cantilevered electrodes 104 coupled together by interconnect 142, in effect splitting the actuation circuit about the signal circuit of cantilevered input/output signal line 102, input/output signal contact structure 110 and signal trace 116.

In addition to including a split actuation circuit, MEMS switch 140 may alternatively include multiple insulating members 144 connecting cantilevered input/output signal lines 102, cantilevered electrode 104, and line 103 at the spaces in between the structures. More specifically, MEMS switch 140 may include segmented portions of insulating member 108 described in reference to MEMS switches 100 and 130. In general, the width of multiple insulating members 144 may be sufficient such that cantilevered input/output signal line 102 and cantilevered electrodes 104 move uniformly toward substrate 120. In addition, the width of multiple insulating members 144 together with the thickness of insulating members 144 may be sufficient to withstand the cycling of closing and opening the switch without cracking. Although such characterizations may depend on the dimensions of cantilevered input/output signal line 102 and cantilevered electrodes 104 as well as the spacings therebetween, the width of insulating members 144 may generally between approximately 5 microns and approximately 50 microns and the thickness of insulating members 144 may be between approximately 0.1 microns and approximately 10 microns. Larger or smaller widths and/or thicknesses may be employed, however, depending on the design specifications of the switch.

As with the configuration of insulating member 108 in MEMS switch 100, insulating members 144 may, in some embodiments, include a stiffer material than included in cantilevered input/output signal line 102 and/or cantilevered electrodes 104. In other embodiments, insulating members 144 may include a more elastic material than cantilevered input/output signal line 102 and/or cantilevered electrodes 104. Furthermore, although FIG. 8c shows insulating members 144 disposed above portions of cantilevered input/output signal line 102 and cantilevered electrodes 104, insulating members 144 may alternatively be disposed below portions of cantilevered input/output signal line 102 and cantilevered electrodes 104. In addition, although FIG. 8c shows insulating members 144 disposed between side portions of cantilevered input/output signal line 102, cantilevered electrodes 104, and line 103, MEMS switch 140 may alternatively have insulating members 144 exclusively disposed above or below the structures and the spaces therebetween. In any case, insulating members 144 may be configured to extend along any portions of cantilevered input/output signal line 102, cantilevered electrodes 104 and/or line 103, including all or partial portions of such structures as described for insulating member 108 in reference to FIGS. 6a-6c above. In addition, insulating members 144 may be spaced away from the free end of the cantilevered structures. Moreover, insulating members 144 may include any shape and/or include any number of cut-outs or extensions. As such, insulating members 144 are not necessarily limited to the illustrations in FIGS. 8a-8c.

It is noted that the inclusion of multiple insulating members 144 is not necessarily specific to SPST MEMS switches or MEMS switches with split actuation circuits. As such, MEMS switch 140 may alternatively insulating member 108 instead of multiple insulating members 144. In addition, MEMS switch 100 of FIGS. 6a-6c or MEMS switch 130 of FIGS. 7a-7c may have insulating members 144 instead of insulating member 108. Furthermore, either of MEMS switch 100 of FIGS. 6a-6c or MEMS switch 130 of FIGS. 7a-7c may be configured with a split actuation circuit.

Alternative configurations of cantilever-based MEMS switches are shown in FIGS. 9a-10c. In particular, FIGS. 9a-10c illustrate cantilever-based MEMS switches which are configured to be less susceptible to malfunctions due to curvature at a free end of the cantilever structure. More specifically, FIGS. 9a-10c illustrate a cantilever-based MEMS switch design which includes a plurality of supports arranged upon a substrate surface, segments extending from the plurality of support structures to a common bar suspended above the substrate surface, and at least one projection extending from the common bar between the segments. In this manner, the switches include a fold-back design in which a free end of the projection is suspended in proximity of the support structures. The free end of the projection (i.e., the end opposing the common bar) is suspended above substrate over a region which includes input/output contact structures. As such, the projection may serve to complete a signal circuit upon actuation of the switch.

As shown in FIGS. 9a-10c, the free end of the projection extends back between two of the support structures. Such a configuration allows the free end of the projection to inherit a smaller range of curvature as compared to the common bar and, therefore, is less susceptible to causing the switch to malfunction. In many cases, the free ends of cantilever beams are apt to curl up or down in the off state due the stress in the beams and the distance of the free ends from support structures. Such curling of beams, however, may undesirably close a switch without applying an actuation voltage (i.e., when the beam curls down) or may undesirably prevent a switch from closing upon application of an actuation voltage (i.e., when the beam curls up). As such, configurations limiting the range of innate curvature at the free end of cantilever structures used to complete a signal circuit may be advantageous.

Turning to FIGS. 9a-9c, MEMS switch 150 is shown having signal circuits separated from actuation circuits. In particular, MEMS switch 150 includes moveable electrode 152 separated from input/output signal line 158 by insulating member 154. FIG. 9a is a plan view of MEMS switch 150, FIG. 9b is a cross-sectional view of MEMS switch 150 taken along line KK of FIG. 9a, and FIG. 9c is a cross-sectional view of MEMS switch 150 taken along line LL of FIG. 9a. MEMS switch 150 includes support structures 160 interposed between substrate 169 and the bottom layer of the cantilevered structure (i.e., moveable electrode 152), which in conjunction with fixed electrodes 162, is configured to electrostatically open and close the switch. In particular, moveable electrode 152 includes trace 153 which is coupled to either high or low voltage potential and fixed electrodes 162 include traces 163 which are coupled to the opposite voltage potential of trace 153.

MEMS switch 150 further includes input/output signal contact structures 164a arranged upon substrate 169 and spaced apart from fixed electrodes 162. Coupled to input/output signal contact structures 164a are input/output traces 165, which are configured for coupling to input/output signal terminals. MEMS switch 150 further includes input/output traces 167 arranged upon substrate 169 and coupled to support structure 166. Support structure 166 is coupled to input/output signal line 158, which in addition to portions 168, make up the top layer of the cantilevered structure. Although not shown, moveable electrode 152, insulating member 154, input/output signal line 158, and portions 168 may include holes to allow air to escape during actuation as well as to allow chemical access to the underside of the electrode during fabrication. As shown in FIGS. 9a-9c, the bottom and top layers are of the cantilevered structure are separated by insulating member 154. In this manner, input/output signal line 158 may be isolated from moveable electrode 152 and the transmission of signals through MEMS switch 150 may be independent of the voltage potential used to induce mechanical action of the switch.

MEMS switch 150 further includes portions 168 with the top layer of the cantilevered structure spaced apart from input/output signal line 158 to provide further support to the exterior segments of the cantilevered structure. Portions 168 may include conductive or dielectric materials as well as any combination of such materials. In some embodiments, portions 168 may include the same material and thickness as moveable electrode 152 and input/output signal line 158 to effectuate the same amount of curvature within the switch. As shown in FIGS. 9a-9c, input/output signal line 158 extends from support structure 166 to the common bar at which segments of moveable electrode 152 and insulating member 154 extend from support structures 160. Each of input/output signal line 158, insulating member 154, and moveable electrode 152 further extends along the projections between support structures 160 and 166. Although input/output signal line 158, insulating member 154, and moveable electrode 152 are shown in FIG. 9a having slightly different alignment along their edges to differentiate the different layers of the cantilevered structure, MEMS switch 150 is not necessarily so limited. In particular, the edges of the components may or may not be aligned.

An alternative configuration of a cantilever-based MEMS switch is illustrated in FIGS. 10a-10c. In particular, FIGS. 10a-10c illustrate MEMS switch 170 having moveable electrode 172 isolated from input/output signal line 158 by insulating members 174. FIG. 10a is a plan view of MEMS switch 170, FIG. 10b is a cross-sectional view of MEMS switch 170 taken along line MM of FIG. 10a, and FIG. 10c is a cross-sectional view of MEMS switch 170 taken along line NN of FIG. 10a. The components of MEMS switch 170 having the same reference numbers as components of MEMS switch 150 may be substantially similar and, consequently, the arrangement of such components are referenced above in reference to FIGS. 9a-9c. MEMS switch 170 differs from MEMS switch 150 by the inclusion of multiple moveable electrodes 172 and multiple insulating members 174.

As shown in FIGS. 10a and 10c, moveable electrodes 172 are disposed within the same plane as input/output signal line 158, isolated therefrom by insulating members 174. More specifically, moveable electrodes 172 include projections extending from the common bar joining the segments extending from support structures 160 and 166. The projections of moveable electrodes 172 are parallel to the projections of input/output signal line 158 extending from the common bar. Insulating members 174 connect these parallel projections such that moveable electrodes 172 and input/output signal line 158 move toward substrate 169 together. The characteristics of insulating members 174 may be substantially similar to the characteristics of insulating members 144 and, therefore, the description of insulating members 144 in reference to FIGS. 8a-8c above is referenced for insulating members 174. It is noted that MEMS switch 170 may alternatively include a single insulating member extending across input/output signal line 158 (including the base line suspended from support structure 166 as well as the projections from the common bar) and the projections of moveable electrodes 172. Such a single insulating member may be disposed above or below input/output signal line 158 and moveable electrodes 172, as described for insulating member 108 in reference to FIGS. 6a-7c.

In some embodiments, laterally separating input/output signal line 158 and moveable electrodes 172 may advantageously allow the components to be sized independently such that the electrical and mechanical properties of the switch may be optimized. For example, the projections of input/output signal line 158 may be configured to have width dimensions sufficient to match impedance of the line with other components of the switch. In addition, moveable electrodes 172 may be configured with width dimensions that govern the elasticity therein such that moveable electrodes 172 do not come into contact with fixed electrodes 162 but are sufficiently flexible for moving input/output signal line 158 in contact with contact structures 164 upon actuation of the switch. The widths of input/output signal line 158 and moveable electrodes 172 are denoted in FIG. 10a by the reference letter W.

Although the different segments associated with each of input/output signal line 158 and moveable electrodes 172 are shown to be substantially similar in FIG. 10a, MEMS switch 170 is not so limited. In particular, input/output signal line 158 and/or moveable electrodes 172 may alternatively have segments of different widths. In addition, although input/output signal line 158 is shown having relatively smaller widths than moveable electrodes 172 in FIG. 10a, input/output signal line 158 may alternatively have the same widths or relatively larger widths than moveable electrodes 172. Exemplary widths for the projections of input/output signal line 158 and moveable electrodes 172 may generally be between approximately 10 microns and approximately 1000 microns. Larger or smaller widths, however, may be employed for projections of input/output signal line 158 and the projections of moveable electrodes 172, depending on the design specifications of the switch.

Methods for fabricating the MEMS switches described herein may generally include processes known in MEMS technology, including deposition, patterning, and polishing techniques. In addition, the methods may employ one or more sacrificial materials with which to form the free space under suspended materials. Exemplary sacrifical materials include but are not limited to polyimide, benzocyclobutene (BCB), silicon dioxide, silicon nitride or silicon oxynitride. As known in the MEMS technology industry, the methods may be configured to accommodate different shapes, different arrangements of components and different component materials. As such, the methods may be dually applied to the plate-based MEMS switches described herein and the cantilever-based MEMS switches described herein.

Furthermore, the two-types of MEMS switches described herein may include similar materials for their conductive and insulating components. In particular, the structures described herein which are configured to insulate structures may include dielectric materials, such as but not limited to polyimide, benzocyclobutene (BCB), silicon dioxide, silicon nitride or silicon oxynitride. In contrast, the structures described herein which are configured to draw a signal through the MEMS switch and/or induce mechanical action to close the switch may include gold, chromium, copper, tantalum, titanium, tungsten, rhodium, ruthenium, or alloys of such metals. In some cases, the conductive components may include multi-layer structures including a combination of such materials. In addition or alternatively, some components of the MEMS switches described herein may include a combination of conductive and dielectric materials, such as described above for contact structures 32 and 34.

As such, although the MEMS switch components described herein are shown having different cross-hatched patterns, some of such components may include the same materials. Alternatively, some of the components illustrated with the same cross-hatched patterns may include different materials. In any case, in an embodiment in which the MEMS switches described herein are incorporated into an integrated circuit, the substrate material upon which they are formed may include, for example, a silicon, ceramic, or gallium arsenide substrate. For example, the substrate may be a monocrystalline silicon substrate or an epitaxial silicon layer grown on a monocrystalline silicon substrate. In addition, the substrate may include a silicon on insulator (SOI) layer, which may be formed upon a silicon wafer. Alternatively, the substrate may be glass, polyimide, metal, or any other substrate material commonly used in the fabrication of microelectromechanical devices.

It will be appreciated to those skilled in the art having the benefit of this disclosure that this invention is believed to provide MEMS switches having components used to induce mechanical action of the switch which are electrically isolated from components of the switch used for the transmission of signals. Further modifications and alternative embodiments of various aspects of the invention will be apparent to those skilled in the art in view of this description. For example, the materials listed for the components of the MEMS switches are not necessarily a complete listing of materials. Other materials known in the MEMS fabrication industry for fabricating switches may be used. It is intended that the following claims be interpreted to embrace all such modifications and changes and, accordingly, the drawings and the specification are to be regarded in an illustrative rather than a restrictive sense.

What is claimed is:

1. A microelectromechanical system (MEMS) switch, comprising:
a moveable plate suspended above a substrate, wherein the moveable plate comprises:
a first electrode suspended over a second electrode arranged on the substrate; and
a first input/output signal contact structure electrically isolated from the first electrode and suspended above a second input/output signal contact structure arranged on the substrate and spaced apart from the second electrode, wherein the first input/output signal contact structure is arranged proximate to the edge of the moveable plate;
a plurality of arms extending from the periphery of the moveable plate; and
a plurality of support structures coupled between the plurality of arms and the substrate.

2. The MEMS switch of claim 1, wherein the first input/output signal contact is further electrically isolated from the plurality of arms.

3. The MEMS switch of claim 2, wherein the first input/output signal contact is further suspended above a third input/output signal contact arranged on the substrate and spaced adjacent to the second input/output signal contact, and wherein the second and third input/output signal contacts are respectively coupled to input and output signal lines.

4. The MEMS switch of claim 1, wherein the first input/output signal contact is electrically coupled to at least one of the plurality of arms, and wherein the at least one arm comprises an input/output signal line.

5. The MEMS switch of claim 1, wherein the moveable plate comprises:
a main section from which the plurality of arms extend; and
an extension from the main section interposed between two of the plurality of arms.

6. The MEMS switch of claim 5, wherein the first input/output signal contact comprises the extension.

7. The MEMS switch of claim 5, wherein the first electrode comprises the extension.

8. The MEMS switch of claim 1, wherein the moveable plate further comprises an insulating member laterally interposed between the first electrode and the first input/output signal contact.

9. The MEMS switch of claim 1, wherein the first input/output signal contact is laterally spaced from the first electrode by an air gap.

10. A microelectromechanical system (MEMS) switch, comprising:
a moveable plate suspended above a substrate, wherein the moveable plate comprises:
a first electrode suspended over a second electrode arranged on the substrate; and
a first input/output signal contact structure electrically isolated from the first electrode and suspended above a second input/output signal contact structure arranged on the substrate and spaced apart from the second electrode;
a plurality of arms extending from the periphery of the moveable plate, wherein one of the plurality of arms is electrically coupled to the first input/output signal contact structure and comprises an input/output signal trace; and
a plurality of support structures coupled between the plurality of arms and the substrate.

11. The MEMS switch of claim 10, wherein another of the plurality of arms is electrically coupled to the first electrode and is further coupled to one of high and low voltage potentials.

12. The MEMS switch of claim 10, wherein the moveable plate further comprises an insulating member arranged over the first electrode and the first input/output signal contact structure.

13. A microelectromechanical system (MEMS) switch, comprising:
a first electrode arranged upon a substrate;
a first input/output signal contact structure arranged upon the substrate and spaced apart from the first electrode; and
a cantilever structure comprising:
a second electrode suspended above the first electrode; and
an input/output signal line spaced apart from the second electrode and arranged above the first input/output signal contact structure.

14. The MEMS switch of claim 13, wherein the cantilever structure further comprises an insulating member connecting the second electrode and the input/output signal line such that the input/output signal line moves toward the first input/output signal contact structure when the second electrode moves by electrostatic force toward the first electrode.

15. The MEMS switch of claim 14, wherein the insulating member is spaced apart from a fixed end of the cantilever structure.

16. The MEMS switch of claim 14, wherein the insulating member is vertically interposed between the second electrode and the input/output signal line.

17. The MEMS switch of claim 14, wherein the insulating member is laterally interposed between the second electrode and the input/output signal line.

18. The MEMS switch of claim 14, wherein the insulating member is arranged above the second electrode and the input/output signal line.

19. The MEMS switch of claim 14, wherein the insulating member is arranged below the second electrode and the input/output signal line.

20. The MEMS switch of claim 13, wherein the second electrode comprises a cantilevered beam suspended above the fixed electrode and anchored to the substrate, and wherein the input/output signal line comprises a cantilevered signal line beam suspended above the first input/output signal contact structure and anchored to the substrate.

21. The MEMS switch of claim 13, wherein the cantilever structure comprises:
a plurality of supports arranged upon the substrate surface;
segments extending from the plurality of support structures to a common bar suspended above the substrate surface; and
at least one projection extending from the common bar between the segments, wherein the projection comprises the second electrode and the input/output signal line.

22. The MEMS switch of claim 13, wherein the cantilever structure comprises a second input/output signal line spaced apart from the second electrode and arranged above a second input/output signal contact structure arranged upon the substrate.

23. The MEMS switch of claim 13, wherein the cantilever structure comprises a third electrode spaced apart from the first input/output signal line and arranged above a fourth electrode arranged upon the substrate.
